(19) United States
(12) Patent Application Publication
(10) Pub. No.: US 2022/0261914 A1
(43) Pub. Date: Aug. 18, 2022

(54) SYSTEM AND METHOD FOR IMPLEMENTING GLOBAL CONTRIBUTIONS ANALYTICS

(71) Applicant: JPMorgan Chase Bank, N.A., New York, NY (US)

(72) Inventors: Ilya SLAVIN, Allen, TX (US); Rosalind O'NEILL, London (GB); Gavin GARDINER, Glasgow (GB)

(21) Appl. No.: 17/623,343

(22) PCT Filed: Jul. 3, 2019
(86) PCT No.: PCT/US2019/040488

§ 371 Date: Dec. 28, 2021

(51) Int. Cl. G06Q 40/06

(52) U.S. Cl. CPC G06Q 40/06

(57) ABSTRACT

An embodiment of the present invention is directed to a Global Contribution Analytics tool that uses data retrieval and analytics technologies to provide insights to various questions, tasks and issues. For example, the Global Contribution Analytics tool identifies what information is going out of the firm, including classification, content source, owners of applications or individuals sending the data out, etc. The Global Contribution Analytics tool manages who can view/access the information, including slices by firm, region, asset class, etc.

### FIELD OF THE INVENTION

The invention relates generally to a system and method for implementing global contributions analytics and reporting for market reference data.

### BACKGROUND OF THE INVENTION

Large financial companies contribute a lot of information to information brokers to be distributed outside their firms. This information includes research reports, client statements, trade confirmations, responses to quotes, etc. The most actively moving and varied category is market data. Data in this category may include index valuations, indicative quotes, reference data for new securities, indications of interest, etc. Information changes at a variable pace per financial security and can move quickly.

For example, a financial entity may send data relating to financial instruments to various data brokers to be distributed to various market participants. With current systems, financial institutions contribute information on hundreds of thousands of products. Financial institutions are concerned with entitlements controls, methods of consumption, cross-company content sharing, dangers of disclosure, etc. As information market has matured, the information that is sent out has unrealized value to others in the market. However, financial institutions cannot currently track what information is sent and with whom is it being shared. Losing track of what data reaches whom results in potential revenue and opportunity loss.

These and other drawbacks exist.

### SUMMARY OF THE INVENTION

According to one embodiment, the invention relates to a system that implements a Global Contributions Analytics tool. The system comprises: a database for storing market reference data associated with contributions data; a secure communications platform that facilitates communication with the plurality of recipients; and a processing engine that comprises a processor programmed to perform the steps comprising: capturing, via the input, contributions data comprising market reference data associated with one or more securities as a first dataset; capturing, via the input, reference data associated with a data broker's display of market and reference data contributed by an entity as a second dataset; merging the first dataset and the second dataset into a merged dataset that represents data contributed to the data broker; mapping the contributions data to a plurality of business associated with an entity; and providing an interactive interface that comprises a plurality of views that identify data that is transmitted; recipients that are receiving the data and one or more entitlements associated with the data, wherein the data comprises classification, content source and data owners.

According to another embodiment, the invention relates to a method that comprises the steps of: storing and managing market reference data associated with contributions data; capturing, via the input, contributions data comprising market reference data associated with one or more securities as a first dataset; capturing, via the input, reference data associated with a data broker's display of market and reference data contributed by an entity as a second dataset; merging the first dataset and the second dataset into a merged dataset that represents data contributed to the data broker; mapping the contributions data to a plurality of business associated with an entity; and providing an interactive interface that comprises a plurality of views that identify data that is transmitted; recipients that are receiving the data and one or more entitlements associated with the data, wherein the data comprises classification, content source and data owners.

The system may include a specially programmed computer system comprising one or more computer processors, interactive interfaces, electronic storage devices, and networks.

The computer implemented system, method and medium described herein provide unique advantages to entities, organizations and other users, according to various embodiments of the invention. The innovative system provides transparency to otherwise restricted utilization details of contributed market and reference data. An embodiment of the present invention may provide global businesses a better handle of where the content they generate is headed and point the way to monetize the content and protect from unintended information property loss. These and other advantages will be described more fully in the following detailed description.

### BRIEF DESCRIPTION OF THE DRAWINGS

In order to facilitate a fuller understanding of the present invention, reference is now made to the attached drawings. The drawings should not be construed as limiting the present invention, but are intended only to illustrate different aspects and embodiments of the invention.

FIG. 1 is an exemplary system architecture of a contribution data bridge, according to an embodiment of the present invention.

FIG. 2 is an exemplary user interface of a Monitoring Dashboard, according to an embodiment of the present invention.

FIG. 3 is an exemplary flow diagram, according to an embodiment of the present invention.

### DETAILED DESCRIPTION OF THE PREFERRED EMBODIMENT(S)

The following description is intended to convey an understanding of the present invention by providing specific embodiments and details. It is understood, however, that the present invention is not limited to these specific embodiments and details, which are exemplary only. It is further understood that one possessing ordinary skill in the art, in light of known systems and methods, would appreciate the use of the invention for its intended purposes and benefits in any number of alternative embodiments, depending upon specific design and other needs.

The present invention recognizes that there is currently insufficient and inconsistent control and governance over the data that an entity, such as a financial institution or firm, contributes externally. This contribution of market data exposes the entity to data loss to competitors and also results in missed opportunities for commercialization and monetization.

An embodiment of the present invention is directed to a Global Contribution Analytics tool that uses data retrieval and analytics technologies to provide insights to various questions, tasks and issues relating to management and distribution of market and reference data. For example, the Global Contribution Analytics tool identifies what information is going out of a financial institution or firm, including classification, content source, owners of applications and/or individuals sending the data out, etc. The Global Contribution Analytics tool manages who can view/access the information, including slices by firm, region, asset class, etc. The Global Contribution Analytics tool addresses data by customer, including what information is available to them for consumption.

The Global Contribution Analytics tool is directed to analyzing and reporting on the way information is produced, determining how the information flows out and ensuring proper entitlements are in place. The Global Contribution Analytics tool may identify the data guardians and their access to information and how that access applies to specific products. When data customers are competitor institutions, the Global Contribution Analytics tool may ensure that access is not given to people who should not see it. For instance, the Global Contribution Analytics tool may not give Credit sales people at other banks access bond prices, while providing access to their private bankers.

An embodiment of the present invention may identify monetization possibilities for the content leaving the financial entity. Current systems do not provide such analytics and firms tend to be blind to the outbound data exposure or upsell opportunities.

An embodiment of the present invention may also implement internal tools that retrieve, categorize, manipulate and/or preserve reference data about content that lives outside an entity's firewalls. In addition, a content-analytics user interface may be built on top of a data store thereby enabling various content owners to analyze as well as slice the information in the ways that presents them with relevant insights.

An embodiment of the present invention may provide global businesses a better handle of where the content they generate is headed and point the way to monetize the content. An embodiment of the present invention may include tick data capture of outgoing information to detect information theft by brokers and clients, analysis of multiple data brokers, ability to use the analytics database as a semaphore for outgoing data to prevent information leakage, etc.

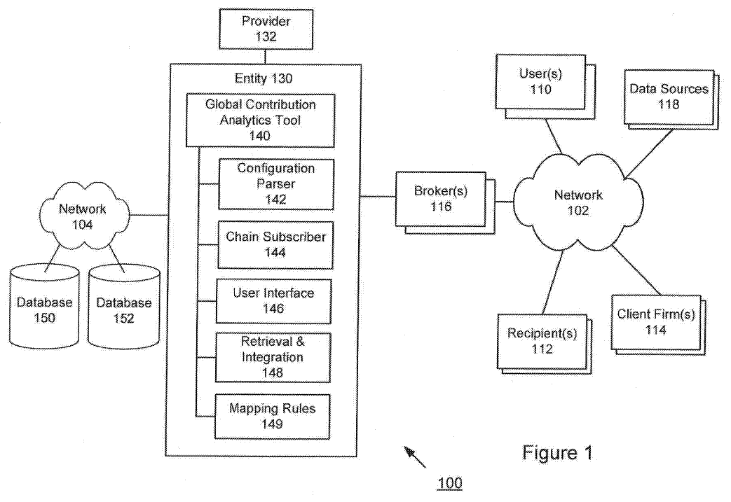

FIG. 1 is an exemplary system architecture of a global contributions analytics system, according to an embodiment of the present invention. Entity, such as a financial institution or firm, may host a Global Contribution Analytics Tool 140. According to an exemplary application, Global Contribution Analytics Tool 140 may include Configuration Parser 142, Chain Subscriber 144, User interface 146, Retrieval & Integration 148 and Mapping Rules 149.

Network 102 may be communicatively coupled with various users and systems, represented by 110. User 110 may communicate with the Global Contribution Analytics Tool 140 via Network 102 and access contribution analytics via UI 146. Global Contribution Analytics Tool may send and/or receive data from various sources, including Recipients 112, Client Firms 114 as well as Data Sources 118. For example, the Tool communicates with Brokers of data 116, using information provided by Brokers as well as information observed as a client of the Broker. As shown in FIG. 1, client firms 114, data sources 118, or other recipients 112 communicate with Broker(s) 116 where the Tool may collect information from the Brokers about these entities and their rights to access content.

The Global Contribution Analytics Tool of an embodiment of the present invention enables Lines of Businesses to easily view the clients that can see their contributed prices, the application/system pricing them, the business/technical owners for the data and the administrators controlling the access. In addition, reports and analytics may be applied and further stored in storage components, such as 150, 152, via Network 104.

The Global Contribution Analytics Tool described herein may be provided by Entity 130 and/or a third party provider, represented by 132, where Provider 132 may operate with an Entity 130, for example. Rules and configuration files may be stored and managed in databases, represented by 150, 152 via Network 104 or in other ways.

The Global Contribution Analytics Tool captures contribution data from various disparate sources and allows the contribution data to be searched for viewing and analysis by users, lines of businesses, etc. An embodiment of the present invention provides a full overview of the data with associated access and permissions. For example, a financial institution may send out executable and indicative prices for credit, rates, government bonds as well as other information that may be needed by traders and sales groups. The Global Contribution Analytics Tool allows entities to control whether or not they should be permitting certain data from being sent out and whether the proper security, entitlements and/or access are associated with the data. Contribution data from disparate sources may be received and mapped.

According to an embodiment of the present invention, the mapping may provide or generate Pricer Flows, where the Pricer Flows may represent a contributing applications list that identifies an application, an individual user, a business owner, etc. The Pricer Flows provide an end-to-end comprehensive view of a particular contribution (e.g., security). Pricer Flows defines the path information takes from the point of origination, though various technical systems, all the way to the Broker.

The Global Contribution Analytics Tool may also ensure that proper security, entitlements and permissions are applied to a particular instrument or group of instruments that may be associated with a Pricer Flow. The Global Contribution Analytics Tool may provide the ability to search for an instrument or Pricer Flow and then display each external individual, team or customer organization that has access to data and the type of access and/or entitlements applied. Historical information may also be provided for additional analysis. In addition, the Global Contribution Analytics Tool may provide insights on who has control over the access of the data, including the ability to enable and disable access and/or permissions.

For example, a search on a particular client may be performed where the user may search an individual or client firm and view the data that the individual or client firm has access to. Historical data may also be provided (e.g., reports on prior access to data). The user may also view data that the individual or client firm can access across various business areas, e.g., research, credit, equities, etc. Other filters may be applied. This analysis provides information on which individuals and recipients can access how much of an entity's data. For example, because the Global Contribution Analytics Tool can determine what information is being sent to a particular client firm or broker, the information may be tailored or customized to the particular broker.

According to another example, the Global Contribution Analytics Tool may be linked to an approval process associated with a particular Pricer Flow or dataset. For example, the Global Contribution Analytics Tool may connect the database of contributions with a business or line of business (LOB) prior to sending contribution data to recipients, such as brokers and client firms. This further enables a business to interrupt and/or modify a transmission to a recipient.

According to another example, an account executive may access the Global Contribution Analytics Tool and determine whether the entity is doing enough business with a particular client firm to justify access to the entity's data. Other analysis and/or reports may be provided to address various business concerns and issues.

Configuration Parser 142 may convert a configuration file or system that defines how a system that delivers data to Broker(s) works into an output such as a file (e.g., JSON file) that may then be stored and managed in a Contribution Database, represented by 150, 152. For example, certain data may be parsed out of the configuration file. The data may include individual records (e.g., internal source record, destination which may include an identifier used when sending data to a destination, etc.), chains (e.g., collections of related individual records that are addressed via the name of the chain, etc.) and general information (e.g., communication parameters, etc.). Data may also include information about different pricer applications, mappings between permissions, securities, owners, etc. It can also contain mappings of contributed data object to specific ticker codes that are used by the data vendor information is to be sent to. Configuration Parser 142 may generate one or more output files. The configuration file may include the links, identifiers, rules mapping and types necessary to describe securities and any chain or other aggregation relationships between them. Chain links may represent a list of data point in a specified order. An embodiment of the present invention may use other ways to connect data points.

Chain Subscriber 144 may listen for and analyze creation or, and changes to, various chains that include data being contributed. Some of these chains may exist for a very short period of time in order for internal publishers to control when their data is sent out to Brokers, so the Chain Subscriber may always be on-line. Chain Subscriber 144 may use an output of Configuration Parser to configure a universe of chain headers to listen to, and its output may be added to that of the Configuration Parser.

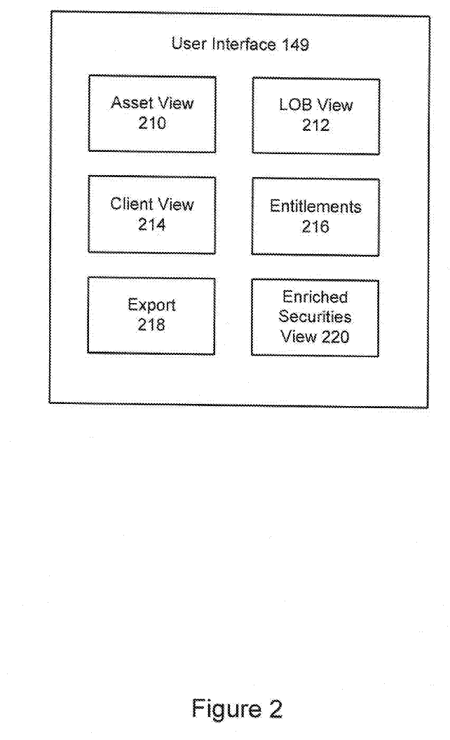

User interface 146 may provide reporting and analytics views. FIG. 2 is a detailed view of User Interface, according to an embodiment of the present invention. As shown in FIG. 2, User Interface 146 may provide various views and information, including Asset View 210, LOB View 212, Client View 214, Entitlements 216, Export 218, and Enriched Securities View 220. Other views and data may be provided in accordance with the various embodiments of the present invention.

Asset View 210 provides analysis and data views across various contributions by an entity. Assets may include indices, fixed income, foreign exchange (FX), warrants and other asset classes. Asset View 210 also provide details regarding how the securities sent out align to asset classes. An exemplary Asset View may include graphics, such as a pie chart or other representative illustration. For example, a size of each pie chart's slice may represent a number of securities and icons that provide counts when a user hovers over the slices. Other interactions may be supported. For example, when a user interacts with (e.g., clicks on) any particular data slice, a chart may appear on a panel and may further list the securities that fall into this category. In addition, search tools (e.g., search bars) in the chart allow a user to find a specific security of interest. Asset View may also be expanded to other graphics, including a table view with additional details. For example, an exemplary Asset View may include a distribution of various types of assets, including bonds, indices, securitized derivatives, swaps, etc. The Asset View may further distinguish between types of assets, including Indices—Research and Indices—Credit. The level of granularity may vary.

Line of Business (LOB) View 212 may provide a view of a number of securities contributed by each line of business. For example, a size of the pie chart's slice may indicate a number of instruments. When one is selected, a graphic, such as a table, may be displayed that allows a user to drill down into details of the types of instruments an LOB is sending out, the way they are secured, and a listing of security details that have been contributed. In addition, the table or other graphic may be filterable beyond the aggregations above. According to an embodiment of the present invention, LOBs may have direct access to the data and that data may be fed directly into a LOB system. The data may be subject to access control, entitlements, permissions and/or other security measures. For example, an exemplary LOB View may identify currencies and emerging markets, global equities, global research, etc. The LOB View may also include indices, identifiers, description, symbol, executable, ticker, broker, etc.

Client View 214 may provide a view, such as a table with search functionality, that lists various clients and/or partners that have been explicitly and/or implicitly granted access to an entity's contributions. When a client is selected, a graphic, such as a pie chart, may appear with information which LOB's securities they are entitled to see. Interacting with (e.g., clicking on) a specific slice may display a graphic, such as a table, with users of that client that have rights to see the data. Other entitlement types may be supported, such as FIRM, which may allow or deny access to the entire organization. Other variations may be applied. For example, an exemplary Client View may provide counts of securities by each client firm. For a particular client, the types of securities may include global equities, global commodities, global credit trading & syndicate, global management & other non-business aligned, global rates & rates exotics, etc. In addition, the client as well as subsidiaries and other variations of the client's name or identifier may be provided for a comprehensive view and analysis.

Entitlements 216 may represent role-based entitlements on top of the User Interface 139. This may permit only authorized users to see the detailed data they are allowed to see.

Export 218 may provide selective export functionality. The rich data in these tables may be used carefully, so only certain power users may be allowed to export table data.

With Enriched Securities View 220, when a contribution goes out of a managed service, an embodiment of the present invention may enrich the per-security display lines with added information, such as last published price, when the last contribution took place, etc. According to an exemplary embodiment, the managed service may be represented by a Consolidated Contributions Data Bridge.

The Global Contribution Analytics Tool described herein may be combined with Market Data Hub, as described in co-pending and commonly assigned patent application (PCT Ser. No. PCT/US19/27185, filed Apr. 12, 2019 (Attorney Docket Number: 72167.001685, which claims priority to U.S. Provisional Application 62/656,585 (Attorney Docket Number 72167.1419) and/or may be further integrated with Consolidated Contributions Data Bridge, as described in co-pending and commonly assigned patent application (PCT Serial Number PCT/US19/27246, filed Apr. 12, 2019 (Attorney Docket Number: 72167.001691)), the contents of which are incorporated by reference herein in their entirety. For example, Consolidated Contributions Data Bridge may send contributions data to various destinations, including Market Data Hub. Global Contribution Analytics Tool may analyze contributions data and further create visibility and analytics.

Retrieval & Integration 148 manages financial instrument details for which an entity has contributed market data to a destination and/or service. This information may be updated on an ad-hoc basis and/or may be refreshed on a periodic basis, e.g., daily basis, with automation. Configuration Parser 142 and Chain Subscriber 144 may collect the “Entity's” view of what data is going out through the channels it manages. An embodiment of the present invention may enable a user to see the data that is sent, but not any type of value add done by the Broker. In contrast, Retrieval and Integration 148 may pull down the reference information about data sent to the Broker as a Broker's clients would see it. This not only picks up the securities sent out through unmanaged channels (which may be more than 50%), but may further access the Broker's value add (this may refer to reference data that is added to the data). Retrieval and Integration 148 further merges Broker's view of the content with the Entity's view provided for the securities that the system can provide a view on.

According to an embodiment of the present invention, an API may be used to retrieve a list of contributed instruments for a given identifier. The identifier may be stored in a database. An embodiment of the present invention may execute an API query for each identifier and generate an output (in JSON format, for example) to be uploaded into a database.

An embodiment of the present invention may be directed to requesting the vendor for pertinent reference data, using their own API to expand it to retrieve more information and then saving it to a database. The movement from staging to final tables implements the mapping rules, keeps history and maintains data integrity.

Mapping Rules 149 may consider securities data to map, types of securities to map, single securities, chain data and/or other types of securities and contribution data. Mapping rules may be used to correlate internally identified securities to their external counterparts and to their relevant pricerflowid and owner. This may be done using a combination of configuration data, manually defined rulesets, permission code property defined rules and defined pattern matching of security identifiers.

An embodiment of the present invention may be directed to mapping an external securities list to an internal securities list and to its contributing application. This mapping process may be divided into functional areas. Other securities may not have an internal security data to map. In this example, the processing may map the external security to its contributing application. Mapping processes may also apply to single securities and chain data.

An embodiment of the present invention may be directed to a staging process that maps datasets, which may include external contributed securities list containing identifiers; internal contributed securities list containing identifiers and contributing applications list, for example.

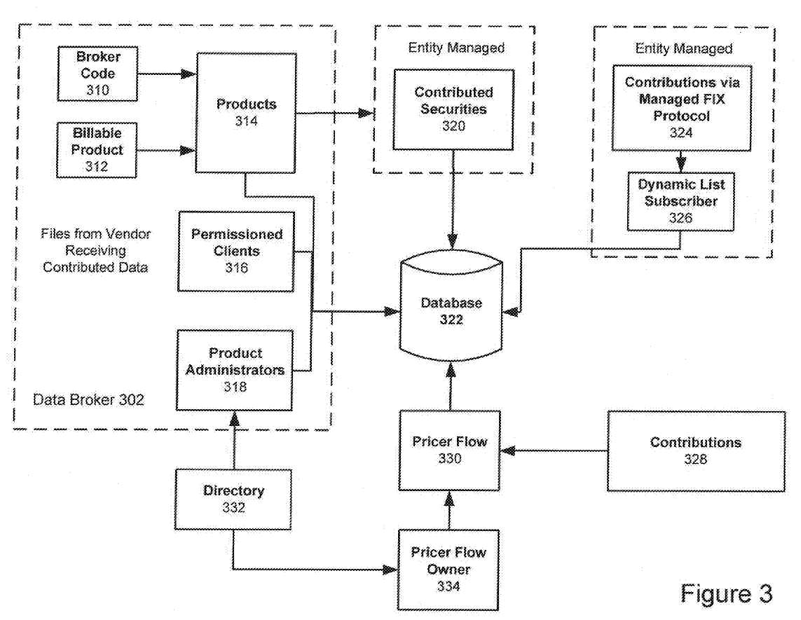

FIG. 3 is an exemplary flow diagram, according to an embodiment of the present invention. FIG. 3 illustrates files (e.g., FTP files) from a vendor receiving contributed data. In this example, Broker Code 310 may include indicative or executable code and Billable Product 312 may be received by Products 314. Products 314 may include entitlement identifiers, and other executable code. Products 314 may communicate with Entity Managed Contributed Securities 320, which may include bonds, indices, currencies, etc. Entity Managed may include Contributions 324, which may include FIX protocol and Dynamic List Subscriber 326. Database 322 may receive Vendor data including Permissioned Clients 316 and Product Administrators 318 as well as Contributed Securities 320, Dynamic List Subscriber 326, Pricer Flow data from 330. As shown in FIG. 3, Pricer Flow data may include applications and user from Contributions 328, Pricer Flow Owner 334. Contributions data may be identified or received via business managed FIX protocol. Pricer Flow Owner 334 may include business and technical data. Directory 332 may drive Product Administrators 318 and Pricer Flow Owner 334.

FIG. 3 illustrates an exemplary process specific to a particular data broker 302. Other implementations may be realized based on different data brokers, for example.

Data Broker 302 makes available reference data about how they define specific parameters of the data an entity contributes to them. Reference data may include specific codes, represented by Broker Code 310, that turn a security from Indicative (e.g., an entity sends the price for such security out so people can see it, but it may differ from what the entity would actually trade) into Executable (e.g., a client may click on a price and move to a trading screen where the trade may occur at that price). Data Broker 302 may also provide information about how clients are charged for an entity's data, represented by Billable Product 312.

Data Broker 302 may provide information (represented by Products 314) about entitlements control codes, which group securities into “buckets” that clients may be entitled to see. They also inform about the way they secure these “buckets” by default. Some may be blocked by default and require explicit “ALLOW” permissions and some are open by default but specific clients may be blocked. The third bucket is a free for all, where no one can ever be blocked.

Information from Products 314 may be used as an input to Retrieval & Integration 148 in FIG. 1, which may be represented by Contributed Securities 320 in FIG. 3. An embodiment of the present invention may query the Broker for reference data on every security for each of the above “buckets” at this stage in order to get the client's view of an entity's data, now enriched by the Data Broker 302.

Contributions may be accessed or received by a protocol, represented by 324. This information may then be provided as input to Contribution Parser 142 and/or Chain Subscriber 144 in FIG. 1. Dynamic List Subscriber 326 may represent a combined functionality of Contribution Parser 142 and/or Chain Subscriber 144.

Contributions 328 may represent line of business applications and end users that send contributions to Data Brokers via various communication mechanisms.

Pricer Flow 330 may represent reference data on various ways information may be contributed and then assembled into “pricer flows,” which track how data moves from an originating line of business function, through technical infrastructure that may or may not belong to that LOB, and ultimately ends up at the Data Broker.

Each Pricer Flow may be associated with a responsible individual, typically a head of that trading desk or originating line of business. This information may be represented by Pricer Flow Owner 334.

An embodiment of the present invention may use information from Directory 332 (e.g., Corporate Directory) to enrich owner information. This enables an entity to uniquely identify an owner as well as provide linkage from individuals to the lines of business they represent.

At Product Administrators 318, an embodiment of the present invention may use Directory data to uniquely identify an entity personnel that are set up by the Broker as security administrators for various products. These administrators may be responsible for protecting the information. An embodiment of the present invention may track that information to help point out possible improvements in various controls.

Data Broker 302 may provide a list of entities (e.g., firms, departments, employees, etc.) that have access permissions to a specific entity's data. For example, such external entities may not be considered employees or authorized users. In this case, data is not available for enrichment.

Database 322 represents various data sources that may be merged or otherwise consolidated into a single database. Database 322 may be merged based on Mapping Rules 149 in FIG. 1 as well as direct information loads for information not specific to contributed instruments. The data may be made available for analytics and presentation to the users.

The system 100 of FIG. 1 may be implemented in a variety of ways. Architecture within system 100 may be implemented as hardware components (e.g., module) within one or more network elements. It should also be appreciated that architecture within system 100 may be implemented in computer executable software (e.g., on a tangible, non-transitory computer-readable medium) located within one or more network elements. Module functionality of architecture within system 100 may be located on a single device or distributed across a plurality of devices including one or more centralized servers and one or more mobile units or end user devices. The architecture depicted in system 100 is meant to be exemplary and non-limiting. For example, while connections and relationships between the elements of system 100 are depicted, it should be appreciated that other connections and relationships are possible. The system 100 described below may be used to implement the various methods herein, byway of example. Various elements of the system 100 may be referenced in explaining the exemplary methods described herein.

Network 102, 104 may be a wireless network, a wired network or any combination of wireless network and wired network. For example, Network 102, 104 may include one or more of an Internet network, a satellite network, a wide area network (“WAN”), a local area network (“LAN”), an ad hoc network, a Global System for Mobile Communication (“GSM”), a Personal Communication Service (“PCS”), a Personal Area Network (“PAN”), D-AMPS, Wi-Fi, Fixed Wireless Data, IEEE 802.11a, 802.11, 802.15.1, 802.11g, 802.11n, 802.11ac, or any other wired or wireless network for transmitting or receiving a data signal. Also, Network 102, 104 may support an Internet network, a wireless communication network, a cellular network, Bluetooth, or the like, or any combination thereof. Network 102, 104 may further include one, or any number of the exemplary types of networks mentioned above operating as a stand-alone network or in cooperation with each other. Network 102, 104 may utilize one or more protocols of one or more network elements to which it is communicatively coupled. Network 102, 104 may translate to or from other protocols to one or more protocols of network devices. Although Network 102, 104 is depicted as one network for simplicity, it should be appreciated that according to one or more embodiments, Network 102, 104 may comprise a plurality of interconnected networks, such as, for example, a service provider network, the Internet, a cellular network, corporate networks, or even home networks, or any of the types of networks mentioned above.

Data may be transmitted and received via Network 102, 104 utilizing a standard networking protocol or a standard telecommunications protocol. For example, data may be transmitted using Session Initiation Protocol (“SIP”), Wireless Application Protocol (“WAP”), Multimedia Messaging Service (“MMS”), Enhanced Messaging Service (“EMS”), Short Message Service (“SMS”), Global System for Mobile Communications (“GSM”) based systems. Code Division Multiple Access (“CDMA”) based systems, Transmission Control Protocol/Internet Protocols (“TCP/IP”), hypertext transfer protocol (“HTTP”), hypertext transfer protocol secure (“ITTPS”), real time streaming protocol (“RTSP”), or other protocols and systems suitable for transmitting and receiving data. Data may be transmitted and received wirelessly or in some cases may utilize cabled network or telecom connections such as an Ethernet RJ45/Category 5 Ethernet connection, a fiber connection, a cable connection or other wired network connection.

While FIG. 1 illustrates individual devices or components, it should be appreciated that there may be several of such devices to carry out the various exemplary embodiments. Entity 130 may communicate with various entities using any mobile or computing device, such as a laptop computer, a personal digital assistant, a smartphone, a smartwatch, smart glasses, other wearables or other computing devices capable of sending or receiving network signals. Output Interface 148 may represent a user interface and/or other interactive communication portal.

Entity 130 may be communicatively coupled to Databases 150, 152. Databases 150, 152 may include any suitable data structure to maintain the information and allow access and retrieval of the information. For example, Databases 150, 152 may keep the data in an organized fashion and may be an Oracle database, a Microsoft SQL Server database, a DB2 database, a MySQL database, a Sybase database, an object oriented database, a hierarchical database, a flat database, and/or another type of database as may be known in the art to store and organize data as described herein.

Databases 150, 152 may be any suitable storage device or devices. The storage may be local, remote, or a combination thereof with respect to Databases 150, 152. Databases 150, 152 may utilize a redundant array of disks (RAID), striped disks, hot spare disks, tape, disk, or other computer accessible storage. In one or more embodiments, the storage may be a storage area network (SAN), an internet small computer systems interface (iSCSI) SAN, a Fiber Channel SAN, a common Internet File System (CIFS), network attached storage (NAS), or a network file system (NFS). Databases 150, 152 may have back-up capability built-in. Communications with Databases 150, 152 may be over a network, or communications may involve a direct connection between Databases 150, 152 and Entity 130, as depicted in FIG. 1. Databases 150, 152 may also represent cloud or other network based storage.

The foregoing examples show the various embodiments of the invention in one physical configuration; however, it is to be appreciated that the various components may be located at distant portions of a distributed network, such as a local area network, a wide area network, a telecommunications network, an intranet and/or the Internet. Thus, it should be appreciated that the components of the various embodiments may be combined into one or more devices, collocated on a particular node of a distributed network, or distributed at various locations in a network, for example. As will be appreciated by those skilled in the art, the components of the various embodiments may be arranged at any location or locations within a distributed network without affecting the operation of the respective system.

As described above, the various embodiments of the present invention support a number of communication devices and components, each of which may include at least one programmed processor and at least one memory or storage device. The memory may store a set of instructions. The instructions may be either permanently or temporarily stored in the memory or memories of the processor. The set of instructions may include various instructions that perform a particular task or tasks, such as those tasks described above. Such a set of instructions for performing a particular task may be characterized as a program, software program, software application, app, or software.

It is appreciated that in order to practice the methods of the embodiments as described above, it is not necessary that the processors and/or the memories be physically located in the same geographical place. Thot is, each of the processors and the memories used in exemplary embodiments of the invention may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two or more pieces of equipment in two or more different physical locations. The two distinct pieces of equipment may be connected in any suitable manner. Additionally, the memory may include two or more portions of memory in two or more physical locations.

As described above, a set of instructions is used in the processing of various embodiments of the invention. The servers may include software or computer programs stored in the memory (e.g., non-transitory computer readable medium containing program code instructions executed by the processor) for executing the methods described herein. The set of instructions may be in the form of a program or software or app. The software may be in the form of system software or application software, for example. The software might also be in the form of a collection of separate programs, a program module within a larger program, or a portion of a program module, for example. The software used might also include modular programming in the form of object oriented programming. The software tells the processor what to do with the data being processed.

Further, it is appreciated that the instructions or set of instructions used in the implementation and operation of the invention may be in a suitable form such that the processor may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processor, i.e., to a particular type of computer, for example. Any suitable programming language may be used in accordance with the various embodiments of the invention. For example, the programming language used may include assembly language, Ada, APL, Basic, C, C++, COBOL, dBase, Forth, Fortran, Java, Modula-2, Pascal, Prolog, REXX, Visual Basic, JavaScript and/or Python. Further, it is not necessary that a single type of instructions or single programming language be utilized in conjunction with the operation of the system and method of the invention. Rather, any number of different programming languages may be utilized as is necessary or desirable.

Also, the instructions and/or data used in the practice of various embodiments of the invention may utilize any compression or encryption technique or algorithm, as may be desired. An encryption module might be used to encrypt data. Further, files or other data may be decrypted using a suitable decryption module, for example.

In the system and method of exemplary embodiments of the invention, a variety of “user interfaces” may be utilized to allow a user to interface with the mobile devices or other personal computing device. As used herein, a user interface may include any hardware, software, or combination of hardware and software used by the processor that allows a user to interact with the processor of the communication device. A user interface may be in the form of a dialogue screen provided by an app, for example. A user interface may also include any of touch screen, keyboard, voice reader, voice recognizer, dialogue screen, menu box, list, checkbox, toggle switch, a pushbutton, a virtual environment (e.g., Virtual Machine (VM)/cloud), or any other device that allows a user to receive information regarding the operation of the processor as it processes a set of instructions and/or provide the processor with information. Accordingly, the user interface may be any system that provides communication between a user and a processor. The information provided by the user to the processor through the user interface may be in the form of a command, a selection of data, or some other input, for example.

The software, hardware and services described herein may be provided utilizing one or more cloud service models, such as Software-as-a-Service (SaaS), Platform-as-a-Service (PaaS), and Infrastructure-as-a-Service (IaaS), and/or using one or more deployment models such as public cloud, private cloud, hybrid cloud, and/or community cloud models.

Although the embodiments of the present invention have been described herein in the context of a particular implementation in a particular environment for a particular purpose, those skilled in the art will recognize that its usefulness is not limited thereto and that the embodiments of the present invention can be beneficially implemented in other related environments for similar purposes.

1. A system that implements a Global Contributions Analytics tool, the system comprising:
a database for storing market reference data associated with contributions data;
a secure communications platform that facilitates communication with the plurality of recipients; and
a processing engine that comprises a processor programmed to perform the steps comprising:
capturing, via the input, contributions data comprising market reference data associated with one or more securities as a first dataset;
capturing, via the input, reference data associated with a data broker's display of market and reference data contributed by an entity as a second dataset;
merging the first dataset and the second dataset into a merged dataset that represents data contributed to the data broker;
mapping the contributions data to a plurality of business associated with an entity; and
providing an interactive interface that comprises a plurality of views that identify data that is transmitted; recipients that are receiving the data and one or more entitlements associated with the data, wherein the data comprises classification, content source and data owners.

2. The system of claim 1, wherein the contributions data comprises executable and indicative prices for one or more of: credit, rates, bonds, Spots, Swaps, Forwards, Financial Indexes; Warrants, Notes, and Derivatives.

3. The system of claim 1, wherein the interactive interface identifies who has control over the one or more entitlements.

4. The system of claim 1, wherein one of the plurality of views comprises an Asset View that provides analysis and data views across a plurality of contributions by an entity.

5. The system of claim 4, wherein the Asset View provides graphics on how one or more securities align with one or more asset classes.

6. The system of claim 5, wherein the asset classes comprise indices, fixed income, foreign exchange.

7. The system of claim 1, wherein one of the plurality of views comprises a Line of Business View that provides a number of securities contributed by each line of business.

8. The system of claim 1, wherein one of the plurality of views comprises a Client View that provides a list of clients that have been granted access to one or more contributions.

9. The system of claim 1, wherein one of the plurality of views comprises an Entitlements View that provides a role-based entitlements data.

10. The system of claim 1, wherein one of the plurality of views comprises an Enriched Securities View that provides additional information generated from a Consolidated Contributions Data Bridge.

11. A method that implements a Global Contributions Analytics tool, the method comprising the steps of:
storing and managing market reference data associated with contributions data;
capturing, via the input, contributions data comprising market reference data associated with one or more securities as a first dataset;
capturing, via the input, reference data associated with a data broker's display of market and reference data contributed by an entity as a second dataset;
merging the first dataset and the second dataset into a merged dataset that represents data contributed to the data broker;
mapping the contributions data to a plurality of business associated with an entity; and
providing an interactive interface that comprises a plurality of views that identify data that is transmitted; recipients that are receiving the data and one or more entitlements associated with the data, wherein the data comprises classification, content source and data owners.

12. The method of claim 11, wherein the contributions data comprises executable and indicative prices for one or more of: credit, rates and bonds, Spots, Swaps, Forwards, Financial Indexes; Warrants, Notes, and Derivatives.

13. The method of claim 11, wherein the interactive interface identifies who has control over the one or more entitlements.

14. The method of claim 11, wherein one of the plurality of views comprises an Asset View that provides analysis and data views across a plurality of contributions by an entity.

15. The method of claim 14, wherein the Asset View provides graphics on how one or more securities align with one or more asset classes.

16. The method of claim 15, wherein the asset classes comprise indices, fixed income, foreign exchange.

17. The method of claim 11, wherein one of the plurality of views comprises a Line of Business View that provides a number of securities contributed by each line of business.

18. The method of claim 11, wherein one of the plurality of views comprises a Client View that provides a list of clients that have been granted access to one or more contributions.

19. The method of claim 11, wherein one of the plurality of views comprises an Entitlements View that provides a role-based entitlements data.

20. The method of claim 11, wherein one of the plurality of views comprises an Enriched Securities View that provides additional information generated from a Consolidated Contributions Data Bridge.
